(19) United States
(12) Patent Application Publication
(10) Pub. No.: US 2026/0333027 A1
(43) Pub. Date: Oct. 22, 2026

(54) SECURITY FOR CONTENTION-BASED TRANSMISSIONS

(71) Applicant: QUALCOMM Incorporated, San Diego, CA (US)

(72) Inventors: Mostafa KHOSHNEVISAN, San Diego, CA (US); Tao LUO, San Diego, CA (US)

(21) Appl. No.: 19/635,233

(22) Filed: Mar. 31, 2026

Related U.S. Application Data
(60) Provisional application No. 63/791,090, filed on Apr. 18, 2025.

(51) Int. Cl. H04W 12/03; H04W 72/21

(52) U.S. Cl. CPC H04W 12/03; H04W 72/21

(57) ABSTRACT

Various aspects of the present disclosure generally relate to wireless communication. In some aspects, a user equipment (UE) may encode, using a first encryption level, a first portion of a contention-based uplink communication to obtain an encoded first portion, the first portion indicating an identifier of the UE. The UE may encode, using a second encryption level, a second portion of the contention-based uplink communication to obtain an encoded second portion. The UE may transmit, as part of the contention-based uplink communication, the encoded first portion and the encoded second portion. Numerous other aspects are described.

### CROSS-REFERENCE TO RELATED APPLICATION

This Patent Application claims priority to U.S. Provisional Patent Application No. 63/791,090, filed on Apr. 18, 2025, entitled “SECURITY FOR CONTENTION-BASED TRANSMISSIONS,” and assigned to the assignee hereof. The disclosure of U.S. Provisional Patent Application No. 63/791,090 is considered part of and is incorporated by reference into this Patent Application.

### FIELD OF THE DISCLOSURE

Aspects of the present disclosure generally relate to wireless communication and specifically relate to techniques, apparatuses, and methods associated with security for contention-based transmissions.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a user equipment (UE) in a wireless communication network may be configured to transmit contention-based uplink communications. In such examples, a resource pool may be configured for multiple UEs rather than configured per-UE. That is, a network node may configure a resource pool and allocate each resource in the resource pool to multiple UEs (that include the UE). The UE may use contention-based admission control to access the resources in the resource pool to transmit uplink communications. As a result, the network node may be unaware of which resources from the resource pool are selected and used by the UE to transmit a given contention-based uplink communication.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to encode, using a first encryption level, a first portion of a contention-based uplink communication to obtain an encoded first portion, the first portion indicating an identifier of the UE. The processing system may be configured to cause the UE to encode, using a second encryption level, a second portion of the contention-based uplink communication to obtain an encoded second portion. The processing system may be configured to cause the UE to transmit, as part of the contention-based uplink communication, the encoded first portion and the encoded second portion.

Some aspects described herein relate to a network node. The network node may include a processing system. The processing system may include one or more processors and one or more code-storing memories coupled with the one or more processors. The processing system may be configured to cause the network node to receive, as part of a contention-based uplink communication associated with a UE, an encoded first portion of the contention-based uplink communication and an encoded second portion of the contention-based uplink communication. The processing system may be configured to cause the network node to decode, using a first encryption level, the encoded first portion to obtain a first portion of the contention-based uplink communication, the first portion indicating an identifier of the UE. The processing system may be configured to cause the network node to decode, using a second encryption level, the encoded second portion to obtain a second portion of the contention-based uplink communication.

Some aspects described herein relate to a method of wireless communication performed by a UE. The method may include encoding, using a first encryption level, a first portion of a contention-based uplink communication to obtain an encoded first portion, the first portion indicating an identifier of the UE. The method may include encoding, using a second encryption level, a second portion of the contention-based uplink communication to obtain an encoded second portion. The method may include transmitting, as part of the contention-based uplink communication, the encoded first portion and the encoded second portion.

Some aspects described herein relate to a method of wireless communication performed by a network node. The method may include receiving, as part of a contention-based uplink communication associated with a UE, an encoded first portion of the contention-based uplink communication and an encoded second portion of the contention-based uplink communication. The method may include decoding, using a first encryption level, the encoded first portion to obtain a first portion of the contention-based uplink communication, the first portion indicating an identifier of the UE. The method may include decoding, using a second encryption level, the encoded second portion to obtain a second portion of the contention-based uplink communication.

Some aspects described herein relate to a non-transitory computer-readable medium that stores a set of instructions for wireless communication by a UE. The set of instructions, when executed by one or more processors of the UE, may cause the UE to encode, using a first encryption level, a first portion of a contention-based uplink communication to obtain an encoded first portion, the first portion indicating an identifier of the UE. The set of instructions, when executed by one or more processors of the UE, may cause the UE to encode, using a second encryption level, a second portion of the contention-based uplink communication to obtain an encoded second portion. The set of instructions, when executed by one or more processors of the UE, may cause the UE to transmit, as part of the contention-based uplink communication, the encoded first portion and the encoded second portion.

Some aspects described herein relate to a non-transitory computer-readable medium that stores a set of instructions for wireless communication by a network node. The set of instructions, when executed by one or more processors of the network node, may cause the network node to receive, as part of a contention-based uplink communication associated with a UE, an encoded first portion of the contention-based uplink communication and an encoded second portion of the contention-based uplink communication. The set of instructions, when executed by one or more processors of the network node, may cause the network node to decode, using a first encryption level, the encoded first portion to obtain a first portion of the contention-based uplink communication, the first portion indicating an identifier of the UE. The set of instructions, when executed by one or more processors of the network node, may cause the network node to decode, using a second encryption level, the encoded second portion to obtain a second portion of the contention-based uplink communication.

Some aspects described herein relate to an apparatus for wireless communication. The apparatus may include means for encoding, using a first encryption level, a first portion of a contention-based uplink communication to obtain an encoded first portion, the first portion indicating an identifier of the apparatus. The apparatus may include means for encoding, using a second encryption level, a second portion of the contention-based uplink communication to obtain an encoded second portion. The apparatus may include means for transmitting, as part of the contention-based uplink communication, the encoded first portion and the encoded second portion.

Some aspects described herein relate to an apparatus for wireless communication. The apparatus may include means for receiving, as part of a contention-based uplink communication associated with a UE, an encoded first portion of the contention-based uplink communication and an encoded second portion of the contention-based uplink communication. The apparatus may include means for decoding, using a first encryption level, the encoded first portion to obtain a first portion of the contention-based uplink communication, the first portion indicating an identifier of the UE. The apparatus may include means for decoding, using a second encryption level, the encoded second portion to obtain a second portion of the contention-based uplink communication.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of contention-based communication and contention-free communication.

FIG. 3 is a diagram of an example associated with security for contention-based transmissions.

FIG. 4 is a diagram illustrating an example process performed, for example, at a user equipment (UE) or an apparatus of a UE.

FIG. 5 is a diagram illustrating an example process performed, for example, at a network node or an apparatus of a network node.

FIG. 6 is a diagram of an example apparatus for wireless communication.

FIG. 7 is a diagram of an example apparatus for wireless communication.

### DETAILED DESCRIPTION

In some wireless communication systems, contention-based uplink communications (such as contention-based physical uplink shared channel (PUSCH) transmissions) may be utilized for the transmission of small, aperiodic uplink data or control signals. A contention-based uplink communication may enable a user equipment (UE) to transmit information without receiving explicit prior scheduling from a network node. This may reduce latency associated with transmitting the information or may conserve network resources that would have otherwise been associated with the network node transmitting scheduling information separately for each communication. The use of contention-based uplink communications may be useful for event-triggered communications (e.g., where the UE and network node are unaware of precisely when the event triggering the communication will occur), such as channel state information (CSI) reports, beam or cell updates, buffer status reports (BSRs), or transmission control protocol (TCP) communications, among other examples. For example, to transmit a contention-based uplink communication, the UE may select one or more time-frequency resources from a resource pool (e.g., which may be configured by the network node). “Time-frequency resource” refers to one or more time domain resources (e.g., a symbol, multiple symbols, a mini-slot, a slot, or another type of time domain resource) and one or more frequency domain resources (e.g., a resource block, multiple resource blocks, a sub-band, or another frequency domain resource). A resource pool (sometimes referred to herein as a “time-frequency” resource pool) may be a set or group of resources (e.g., time domain resources, frequency domain resource, spatial domain resources, or code domain resources) configured for the UE for a given purpose or communication type, such as for contention-based uplink communications. For example, the resource pool may include resources that are available for use or for selection by the UE for the given purpose or communication type. The UE may transmit the contention-based uplink communication using the selected time-frequency resource(s) (e.g., without receiving an explicit grant or scheduling from the network node for the contention-based uplink communication).

In some wireless communication systems, security or encryption protocols may be used to protect the integrity, confidentiality, or authenticity of information transmitted over a wireless communication network. The security or encryption protocols (such as ciphering protocols) may include mutual authentication between a UE and a network node, encryption of data or signaling messages, or integrity protection to ensure that data has not been tampered with. In some examples, encryption keys may be dynamically generated and managed using secure key exchange protocols or one or more encryption algorithms, such as an advanced encryption standard (AES) protocol, among other examples. This may be referred to as “UE-specific” encryption (e.g., in which one or more encryption parameters (such as an encryption key, initialization vector or seed, a pseudo-random seed, a cipher mode, or a key length, among other examples) used for the security or encryption protocols are specific to a given UE). In some examples, security enhancements have been introduced for medium access control (MAC) signaling (e.g., for MAC control elements (MAC-CEs)) or Layer 2 communications to address vulnerabilities in unencrypted communications. For example, a MAC-CE may be encrypted to prevent unauthorized access and interception. This improves security for information transmitted via MAC signaling, such as scheduling requests, BSRs, or TCP information, among other examples.

In some examples, a contention-based uplink communication may be transmitted via MAC signaling (e.g., in one or more MAC-CEs). As described herein, because a contention-based uplink communication is transmitted without an explicit grant or scheduling, the network node may be unaware of which UE has transmitted a given contention-based uplink communication (e.g., until after the network node decodes and obtains information included in the given contention-based uplink communication). The contention-based nature of the communication may complicate the implementation of security or encryption protocols. For example, because the network node does not know which UE is transmitting the contention-based uplink communication, the network node cannot apply UE-specific encryption to decrypt or decode the contention-based uplink communication (e.g., because the network cannot obtain the encryption key for the UE-specific encryption without knowing which UE transmitted the contention-based uplink communication). Therefore, existing security or encryption protocols may be inapplicable for contention-based uplink communications. As a result, the UE may transmit the contention-based uplink communication without applying a security or encryption protocol (e.g., without encrypting the content of the contention-based uplink communication), thereby increasing security risks for the contention-based uplink communication.

Additionally, because the network node may not obtain an indication of transmission parameters or resources to be used for a given contention-based uplink communication prior to transmission of the given contention-based uplink communication, an indication of the transmission parameters or resources may be separately encrypted and transmitted by the UE to enable the network node to obtain the transmission parameters or resources prior to decryption or decoding the given contention-based uplink communication. This may increase decoding or decrypting complexity for the network node or reduce the efficiency of the contention-based uplink communications.

Various aspects relate generally to enhancing the security and efficiency of contention-based uplink communications. Some aspects more specifically relate to the implementation of selective (or separate) encryption and encoding for portions of contention-based uplink communications. In some aspects, a UE may encode a first portion of the contention-based uplink communication. The first portion may include or indicate an identifier of the UE. The UE may encode the first portion using (or applying) a first encryption level. The UE may encode a second portion of the contention-based uplink transmission using (or applying) a second encryption level. “Encryption level” refers to a level or amount, if any, of encryption to be applied by the UE. In some examples, an encryption level may indicate an encryption protocol or scheme to be applied by the UE. The encryption level may also be referred to as a security level, a ciphering level, a protection level, an encryption strength, an encryption class, a security tier, or an encryption tier, among other examples. The UE may transmit the encoded first portion and the encoded second portion as part of the contention-based uplink communication.

In some aspects, the first encryption level may indicate that no encryption is applied to the first portion. For example, the contention-based uplink communication may include an indication of the identifier of the UE in an unencrypted manner. As another example, the first encryption level may be associated with resource-specific encryption being applied to the first portion. “Resource-specific” encryption refers to an encryption technique in which one or more encryption parameters are based on, derived from, or otherwise associated with resources associated with a transmission. As an example, the resources associated with the transmission may include one or more time-frequency resources (e.g., the resource-specific encryption may be based on, derived from, or otherwise associated with a resource identifier of the time-frequency resource(s)), spatial domain resources, code domain resources, or other resources used for the transmission. As another example, the resource-specific encryption may be based on, derived from, or otherwise associated with a group identifier configured for the UE, where the group identifier is included in the resources associated with the transmission. The second encryption may be associated with UE-specific encryption being applied to the second portion. The second portion may include a CSI report, a beam report, an event-triggered report, a BSR, hybrid automatic repeat request (HARQ) feedback, a TCP acknowledgment, or uplink data, among other examples. The UE may transmit the encoded first portion and the encoded second portion using the same time-frequency resources or different time-frequency resources.

In some examples, the first portion may include an indication of one or more transmission parameters to be used for the second portion. The one or more transmission parameters may include an indication of time-frequency resource(s) to be used for transmission of the encoded second portion (e.g., in an example where the UE transmits the encoded first portion and the encoded second portion using different time-frequency resources). Additionally, or alternatively, the one or more transmission parameters may include a HARQ identifier (an identifier used to associate a transmission or retransmission with a particular HARQ process), a new data indicator (NDI) (an indication of whether a transmission carries new data or a retransmission of previously transmitted data), a redundancy version (RV) (an indication of which redundancy pattern or version is used for a transmission, such as for incremental redundancy in retransmissions), a modulation and coding scheme (MCS) (an indication of a selected modulation order and coding rate to be used for a transmission), an indication of whether the encoded portion is to be transmitted (such as for configured grant (CG) skipping in which the UE does not transmit on a CG occasion, such as when there is no data available for transmission), or an indication associated with a payload size of the second portion, among other examples.

Particular aspects of the subject matter described in this disclosure can be implemented to realize one or more of the following advantages. By the UE encoding the first portion of the contention-based uplink transmission with a first encryption level (which may involve no encryption or a resource-specific encryption) and the second portion with a second encryption level (which may be more secure than the first encryption level), the described techniques can be used to ensure that the network node can decode the first portion to identify the UE and still maintain the security of the contention-based uplink communication. For example, by the UE encoding the first portion of the contention-based uplink transmission with a first encryption level (which may involve no encryption or a resource-specific encryption), the network node can identify the UE by decoding the unencrypted first portion or by decrypting the first portion using one or more encryption parameters (e.g., an encryption key) that are associated with, or mapped to, the time-frequency resource(s) via which the encoded first portion is received by the network node. This enables the network node to decode or decrypt the second portion using the second encryption level (e.g., using UE-specific encryption) because the network node obtains an indication of the identifier of the UE via the first portion.

In some aspects, by the UE including one or more transmission parameters or resource information for the second portion in the first portion, a complexity of securing, encoding, or decoding the second portion may be reduced because the network node may obtain the one or more transmission parameters or resource information for the second portion via the first portion.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

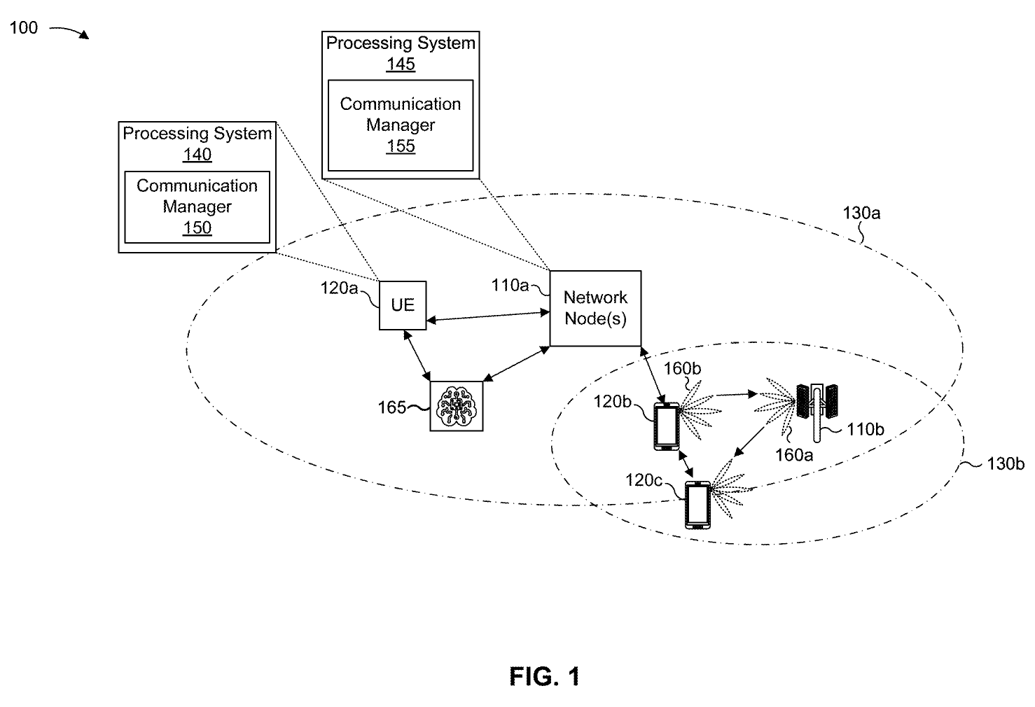

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may encode, using a first encryption level, a first portion of a contention-based uplink communication to obtain an encoded first portion, the first portion indicating an identifier of the UE; encode, using a second encryption level, a second portion of the contention-based uplink communication to obtain an encoded second portion; and transmit, as part of the contention-based uplink communication, the encoded first portion and the encoded second portion. Additionally, or alternatively, the communication manager 150 may perform one or more other operations described herein.

In some aspects, the network node 110 may include a communication manager 155. As described in more detail elsewhere herein, the communication manager 155 may receive, as part of a contention-based uplink communication associated with a UE, an encoded first portion of the contention-based uplink communication and an encoded second portion of the contention-based uplink communication; decode, using a first encryption level, the encoded first portion to obtain a first portion of the contention-based uplink communication, the first portion indicating an identifier of the UE; and decode, using a second encryption level, the encoded second portion to obtain a second portion of the contention-based uplink communication. Additionally, or alternatively, the communication manager 155 may perform one or more other operations described herein.

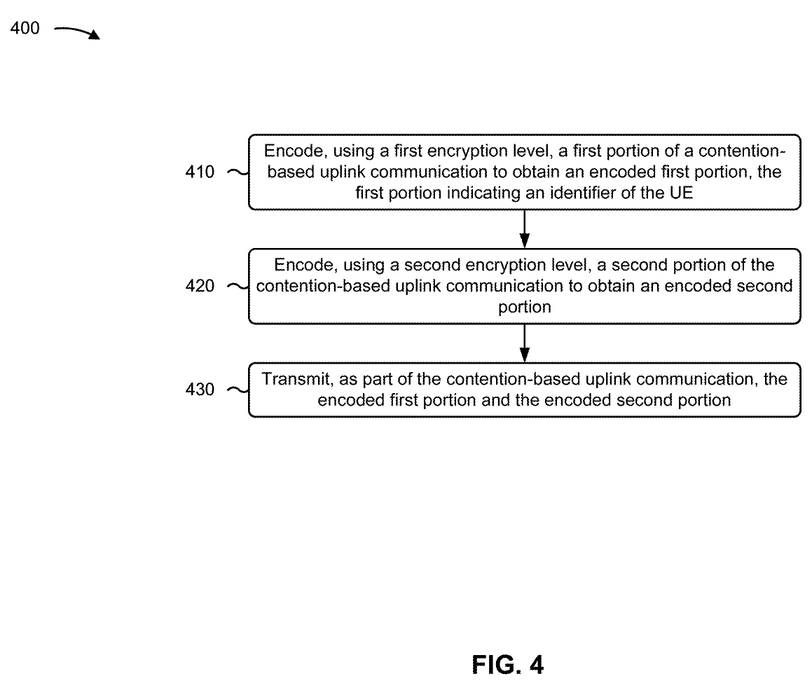

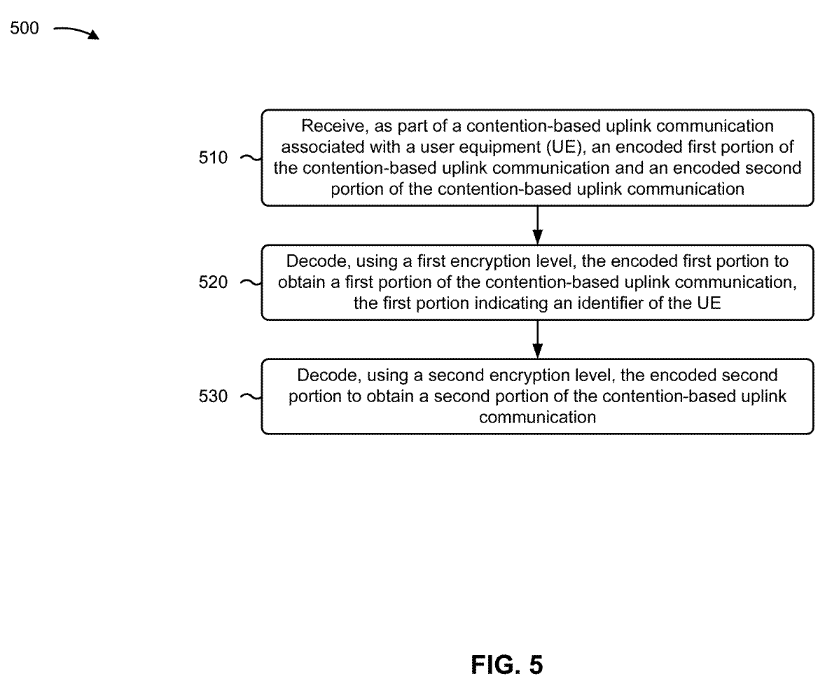

The network node 110, the processing system 145 of the network node 110, the UE 120, the processing system 140 of the UE 120, or any other component(s) of FIG. 1 may implement one or more techniques or perform one or more operations associated with security for contention-based transmissions, as described in more detail elsewhere herein. For example, the processing system 145 of the network node 110, or the processing system 140 of the UE 120 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, or other processes as described herein. In some examples, executing instructions may include running the instructions, converting the instructions, compiling the instructions, or interpreting the instructions, among other examples.

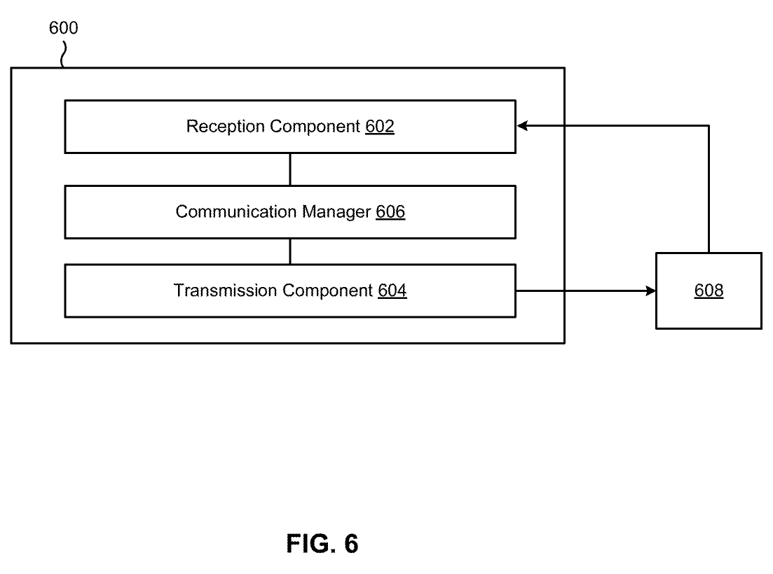

In some aspects, the UE 120 includes means for encoding, using a first encryption level, a first portion of a contention-based uplink communication to obtain an encoded first portion, the first portion indicating an identifier of the UE; means for encoding, using a second encryption level, a second portion of the contention-based uplink communication to obtain an encoded second portion; or means for transmitting, as part of the contention-based uplink communication, the encoded first portion and the encoded second portion. The means for the UE 120 to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

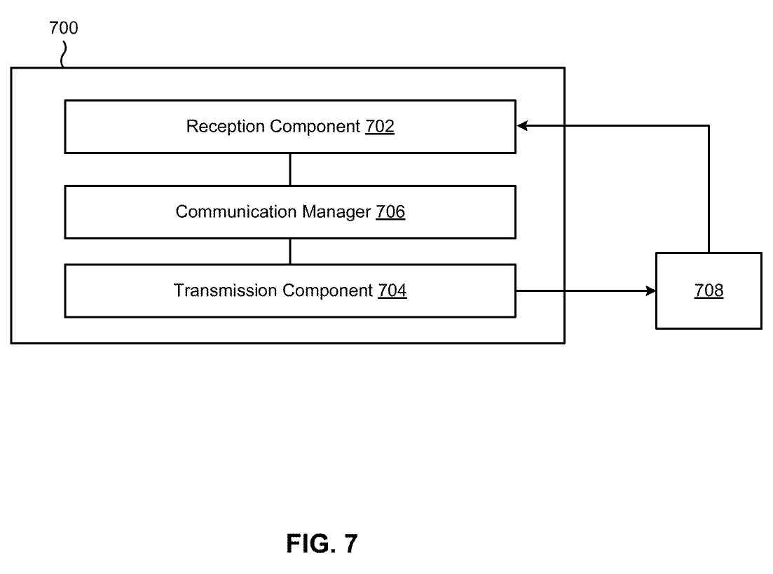

In some aspects, the network node 110 includes means for receiving, as part of a contention-based uplink communication associated with a UE, an encoded first portion of the contention-based uplink communication and an encoded second portion of the contention-based uplink communication; means for decoding, using a first encryption level, the encoded first portion to obtain a first portion of the contention-based uplink communication, the first portion indicating an identifier of the UE; or means for decoding, using a second encryption level, the encoded second portion to obtain a second portion of the contention-based uplink communication. The means for the network node 110 to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

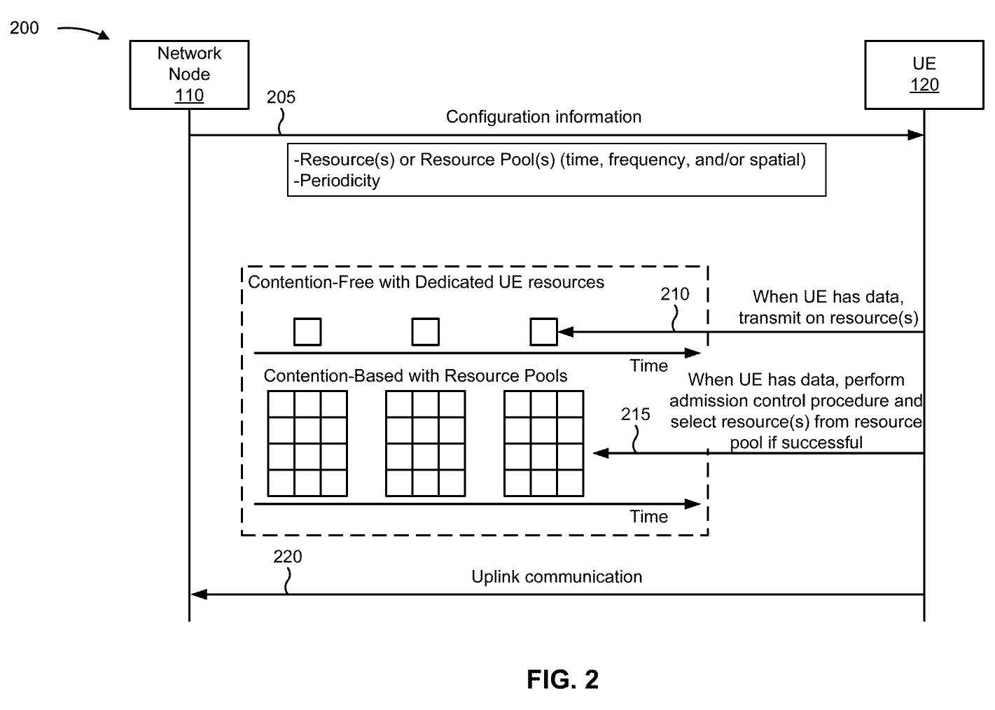

FIG. 2 is a diagram illustrating an example 200 of contention-based communication and contention-free communication. As shown, example 200 includes a network node (e.g., network node 110) and a UE (e.g., UE 120).

As shown in FIG. 2, and by reference number 205, the network node 110 may transmit, and the UE 120 may receive, configuration information. The configuration information may be associated with contention-based uplink communications. In some examples, the configuration information may indicate one or more resources (or a resource pool) that are available for use by the UE 120 to transmit the contention-based uplink communications. Additionally, or alternatively, the configuration information may indicate one or more transmission parameters for the contention-based uplink communications. As an example, the network node 110 may transmit configuration information (e.g., via RRC signaling, DCI, or a MAC-CE, among other examples) that identifies a configured grant (CG). In some examples, the configuration information identifying the CG may indicate a resource allocation (e.g., including one or more of time domain resources, frequency domain resources, spatial domain resources, or code domain resources, among other examples) and a periodicity associated with the resource allocation (e.g., for contention-free CG communications). The CG may identify a resource or set of resources in which the UE 120 is to perform an uplink communication. For example, the CG may identify a resource allocation for a PUSCH of the UE 120 (e.g., for a contention-free CG communication). In some examples, the CG may identify a resource pool or multiple resource pools which may be available for the UE 120 to perform an uplink transmission (e.g., for contention-based CG communications). A CG communication is one example of contention-based uplink communication. In some examples, a contention-based uplink communication may be used by the UE 120 to transmit small aperiodic uplink data or control information. For example, a contention-based uplink communication may be used by the UE 120 to transmit event-triggered CSI (e.g., where the transmission of the CSI is triggered by an event, such as a certain change in a CQI, RI, or other parameter), an event-triggered beam or cell report (e.g., triggered by a measurement parameter of a new beam becoming better than a current serving beam), a BSR, a multi-bit scheduling request, or a TCP ACK, among other examples.

In some examples, the configuration information received by the UE 120 may configure a contention-free communication with resources (e.g., time-frequency resources) dedicated for the UE to transmit uplink communications. In such examples, the configuration information may indicate a resource allocation dedicated for the UE 120 to use to transmit uplink communications (e.g., contention-free uplink communications). The configuration information may also configure the resource allocation for the UE 120 to occur periodically, such that the resource allocation corresponds to periodically occurring transmission time occasions. As shown in FIG. 2, and by reference number 210, when the UE 120 has uplink data to transmit, the UE 120 may transmit the uplink data on the resources indicated by the configuration information. For example, the UE 120 may transmit the uplink data in one of a CG uplink occasions indicated in a CG configuration using the configured resource allocation.

A CG configuration with regular periodic CG uplink occasions with a dedicated resource allocation for the UE may be convenient for a UE 120 with periodic uplink traffic (e.g., with trivial jitter). The CG configuration may configure the periodicity associated with the resource allocation to associate CG uplink occasions with periodic nominal arrival times at which traffic to be transmitted to the network node 110 is expected to arrive at (or be ready to be transmitted by) the UE 120. However, the actual arrival times at which the traffic arrives (or is ready to be transmitted) by the UE 120 may be different than the nominal arrival times, and this difference in times is known as jitter.

In some examples, configurations with dedicated resources allocated per UE may be inefficient. For example, configurations with dedicated UE resources for a large number of UEs may result in consumption of an excessive amount of PUSCH resources or other uplink resources. In such examples, a considerable portion of the PUSCH resources may be inefficiently utilized, which reduces system capacity. For example, when multiple CG configurations for a UE are used for de-jittering, only a subset of CG resources may be effectively utilized. In another example, when multiple transmission opportunities are defined per CG uplink occasion, only one opportunity may be effectively utilized. In yet another example, when a blind repetition scheme is used for re-transmissions, a packet may have been already decoded after the first one or more repetitions (early decoding) such that a remainder of the repetitions are unnecessary. Unlike a downlink case, this type of inefficient consumption of system resources cannot be addressed by scheduling, as the network node 110 does not know exactly when traffic will arrive at the UEs.

In some examples, statistical multiplexing schemes may be used to allocate CG uplink resource access among multiple UEs. Statistical multiplexing of CG uplink communications from multiple UEs may be useful in cases in which there are a high number of UEs associated with somewhat random traffic arrivals at the network node or cases in which a traffic arrival density for traffic arriving at the UEs is time varying, among other examples. For example, statistical multiplexing of CG uplink communications from multiple UEs may be useful for a network deployment, such as an industrial wireless sensor network, with a large capacity of UEs. In such cases, the uplink traffic associated with at least a group of UEs may be delay insensitive.

As shown in FIG. 2, the configuration information received by the UE 120 may configure a contention-based CG with resource pools that are available for multiple UEs to use to transmit uplink communications. The contention-based configuration uses statistical multiplexing to share the resource pools among multiple UEs. A resource pool includes multiple resources (e.g., time domain, frequency domain, spatial domain, or code domain) that can be allocated for contention-based uplink transmission by the UE 120. For example, a horizontal axis of a resource pool may indicate transmission times and the vertical axis of the resource pool may indicate resources (e.g., frequency domain resources, spatial domain resources, or code domain resources, among other examples) that can be allocated at each transmission time. In some aspects, the same resource pools may be configured for multiple UEs.

Statistical multiplexing schemes may involve spreading control and overloading control. For example, spreading relates to distributing traffic (as interference to others) into a resource pool.

As further shown in FIG. 2, and by reference number 215, for the contention-based configuration, when the UE 120 has uplink data to be transmitted, the UE 120 may perform an admission control procedure and may select one or more resources from the resource pool if the admission control procedure is successful. In some examples, the admission control procedure may include the UE 120 selecting a random number (e.g., between 0 and 1), comparing the random number with a threshold, and determining whether the random number satisfied the threshold. If the random number satisfies the threshold, the admission is successful and the UE 120 may select a resource from the resource pool to transmit the contention-based uplink communication.

In some examples, the network node 110 may control the probability of the UE 120 accessing the resource pool by setting or adjusting the threshold. For example, the network node 110 may dynamically adjust the threshold to let more or fewer UEs access the resource pool in order to prevent resource collisions. Additionally, or alternatively, the network node 110 may assign different thresholds to be used by different UEs.

In response to the UE 120 determining that the random number satisfies the threshold, the UE 120 may select a resource from the resource pool to transmit the contention-based uplink communication. The UE 120 may select the resource from the resource pool using randomized or pseudo-randomized resource selection. For example, the UE 120 may use a hashing function based at least in part on a UE identifier, time, or resource pool index to select the resource from the resource pool.

As further shown in FIG. 2, and by reference number 220, the UE 120 may transmit the uplink communication (e.g., the contention-free uplink communication or the contention-based uplink communication) to the network node 110 on the resource. For example, the UE 120 may transmit the uplink communication as a PUSCH communication using a resource allocation identified by the configuration information (e.g., for a contention-free uplink communication) or using a selected resource from the resource pool (e.g., for a contention-based uplink communication).

In examples, security or encryption protocols may be used to protect the integrity, confidentiality, or authenticity of information transmitted over a wireless communication network, such as the wireless communication network 100. The security or encryption protocols (such as ciphering protocols) may include mutual authentication between the UE 120 and the network node 110, encryption of data or signaling messages, or integrity protection to ensure that data has not been tampered with. In some examples, encryption keys may be dynamically generated and managed using secure key exchange protocols or one or more encryption algorithms, such as an AES protocol, among other examples.

In some examples, the UE 120 may transmit a contention-based uplink communication via MAC signaling (e.g., in one or more MAC-CEs). As described herein, because a contention-based uplink communication is transmitted without an explicit grant or scheduling from the network node 110, the network node 110 may be unaware of which UE has transmitted a given contention-based uplink communication (e.g., until after the network node decodes and obtains information included in the given contention-based uplink communication). The contention-based nature of the communication may complicate the implementation of security or encryption protocols. For example, because the network node 110 does not know which UE is transmitting the contention-based uplink communication, the network node 110 cannot apply UE-specific encryption to decrypt or decode the contention-based uplink communication (e.g., because the network cannot obtain the encryption key for the UE-specific encryption without knowing which UE transmitted the contention-based uplink communication). Therefore, existing security or encryption protocols may be inapplicable for contention-based uplink communications. As a result, the UE 120 may transmit the contention-based uplink communication without applying a security or encryption protocol (e.g., without encrypting the content of the contention-based uplink communication), thereby increasing security risks for the contention-based uplink communication.

As indicated above, FIG. 2 is provided as an example. Other examples may differ from what is described with respect to FIG. 2.

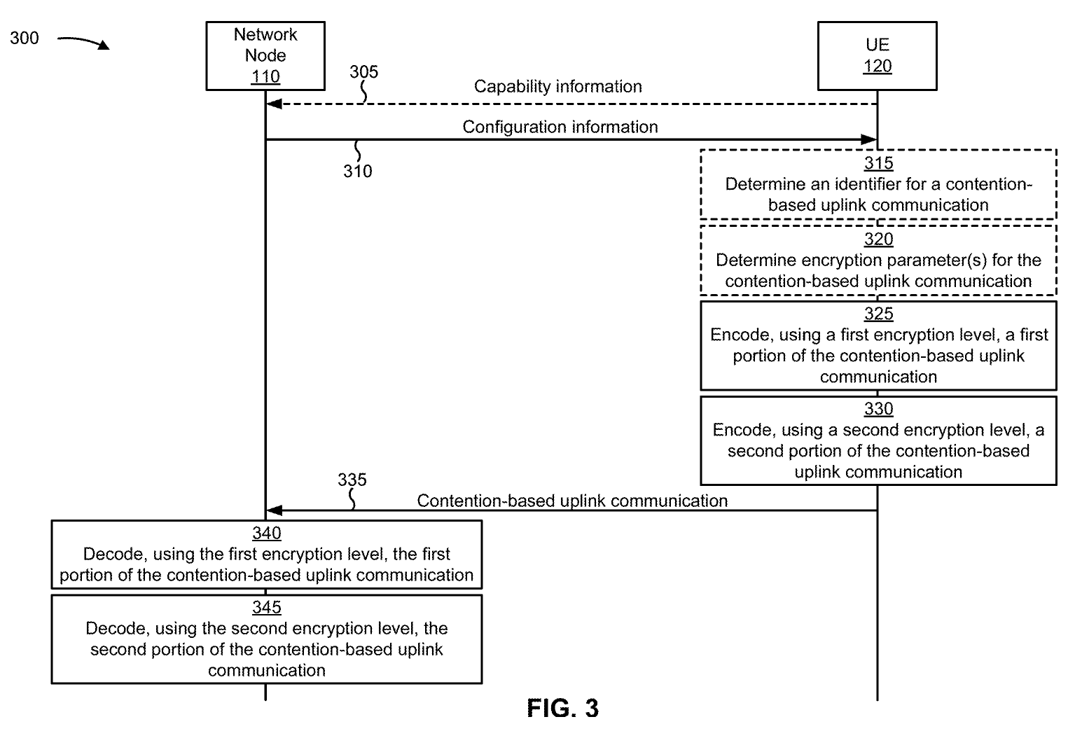

FIG. 3 is a diagram of an example 300 associated with security for contention-based transmissions. As shown in FIG. 3, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 3.

In some aspects, as shown by reference number 305, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for separate security or encryption for two or more portions of contention-based uplink communications. For example, the capability information may indicate that the UE 120 supports separately encoding or encrypting different portions of a contention-based uplink communication, such as a first portion that includes an identifier of the UE 120 and a second portion that includes content or a payload of the contention-based uplink communication. As another example, the capability information may indicate a capability or parameter for resource-specific encryption for a first portion (e.g., that includes an identifier of the UE 120) of the contention-based uplink communication. One or more operations described herein may be based on the capability information. For example, the UE 120 may perform a communication in accordance with the capability information, or may receive configuration information that is in accordance with the capability information.

In some aspects, the capability information may indicate UE support for encryption of the first portion of a contention-based uplink communication. The capability information may also indicate support for resource-specific encryption for the first portion. Furthermore, the capability information may indicate support for pseudo-random hopping of a UE identifier indicated in the first portion of the contention-based uplink communication. Additionally, or alternatively, the capability information may indicate support for pseudo-random hopping of one or more encryption parameters (e.g., an encryption key) used to encrypt the first portion of the contention-based uplink communication. The capability information enables the network node 110 to efficiently configure secure contention-based transmissions based on, or otherwise associated with, the capabilities of the UE 120.

As shown by reference number 310, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to perform separate encoding or encrypting of different portions of contention-based uplink communications (e.g., that are PUSCH communications or other types of uplink communications). For example, the configuration information may indicate that the UE 120 is to apply a first encryption level to a first portion of contention-based uplink communications. The configuration information may indicate that the UE 120 is to apply a second encryption level to a second portion of contention-based uplink communications. The first portion may include an indication of an identifier of the UE 120 (e.g., a UE identifier). The second portion may include content or a payload of the contention-based uplink communication. For example, the second portion may include CSI, a beam report, a measurement report, an event-triggered report, HARQ feedback, a BSR, a scheduling request, a TCP acknowledgement indication, uplink data, or other information or content. The first portion may be referred to as an unencrypted portion, or a limited encryption portion, among other examples. The second portion may be referred to as an encrypted portion, or a fully encrypted portion, among other examples.

For example, the first encryption level may be associated with a first encryption key. In other words, the configuration information may indicate that the UE 120 is to use the first encryption key to encrypt first portions (e.g., that include a UE identifier) of contention-based uplink communications. The second encryption level may be associated with a second encryption key. In other words, the configuration information may indicate that the UE 120 is to use the second encryption key to encrypt second portions (e.g., that include a content or a payload) of contention-based uplink communications. In some aspects, the first encryption key may be shorter (or smaller) than the second encryption key. By using a shorter or smaller encryption key for the first portion, the efficiency or processing overhead for encryption may be improved by configuring the UE 120 to apply lighter (or less processing resource-intensive) encryption to less sensitive information (such as the UE identifier) while reserving stronger encryption for more sensitive data or information. Additionally, by using the different encryption levels, the techniques described herein enhance security by ensuring that the different parts of the contention-based uplink communication are protected or secured according to specific security needs of different portions of the contention-based uplink communication.

The configuration information may indicate that the first encryption level is associated with no encryption or ciphering being applied for the first portion. For example, the UE 120 may transmit the first portion of the contention-based uplink communication without any encryption to allow the network node 110 to identify the UE without needing decryption keys or other encryption parameters. In other aspects, the configuration information may indicate that the first encryption level is a resource-specific encryption. Resource-specific encryption may also be referred to as group-common encryption.

For example, the configuration information may indicate that the UE 120 is to encrypt the first portion of the contention-based uplink communication based on the time-frequency resources used for transmission of the first portion. For example, the configuration information may indicate sets of one or more encryption parameters for the resource-specific encryption. A set of one or more encryption parameters may indicate an encryption key to be applied to the first portion of a contention-based uplink communication if the first portion is transmitted using time-frequency resource(s) associated with, or mapped to, the set of one or more encryption parameters (e.g., as indicated by the configuration information). For example, the sets of one or more encryption parameters may be associated with respective time-frequency resources included in a time-frequency resource pool for the contention-based uplink communication. The configuration information may indicate the time-frequency resource pool.

In an example where resource-specific encryption is used, the configuration information may indicate separate encryption parameters for each time-frequency resource included in the time-frequency resource pool (or for one or more time-frequency resources included in the time-frequency resource pool, such as for subsets of time-frequency resources from a set of time-frequency resources included in the time-frequency resource pool). Each time-frequency resource included in the time-frequency resource pool may be associated with, or mapped to, a respective resource identifier. In some example, the time-frequency resources in the time-frequency resource pool may each include spatial domain resources in addition to time and frequency domain resources. As an example, the UE 120 or the network node 110 may determine the one or more encryption parameters for the first encryption level based on, using, or otherwise associated with a resource identifier of the one or more time-frequency resources (e.g., selected by the UE 120 from the time-frequency resource pool) used for transmission of the first portion. For example, the configuration information may indicate a mapping between encryption parameter(s) and resource identifiers for respective time-frequency (or spatial) resources included in the time-frequency resource pool. This enables the network node 110 to identify one or more encryption parameters to use to decode or decrypt a first portion of a contention-based uplink communication based on the time-frequency resource(s) (e.g., based on the resource identifier of the time-frequency resource(s)) in which the first portion is received (e.g., without having to know which UE transmitted the first portion). As a result, the first portion may be secured using the resource-specific encryption, thereby improving the security of the first portion and enabling the network node 110 to decode or decrypt the first portion without knowing which UE transmitted the first portion.

In some aspects, the configuration information may indicate first content to be included in first portions of contention-based uplink communications and second content to be included in second portions of contention-based uplink communications. For example, the configuration information may indicate whether the first content is to include one or more transmission parameters associated with the second portion. For example, the UE 120 may be configured with which information is to be included as part of the first portion (e.g., that is secured with no encryption or limited encryption) versus as part of the second portion (e.g., that is secured with full encryption). For example, the one or more transmission parameters may include a HARQ identifier, a new data indicator (NDI), a redundancy version, an MCS, an indication of whether the second portion is to be transmitted (such as for CG-skipping), or an indication associated with a payload size of the second portion (e.g., an indication of the payload size), among other examples. In some aspects, the configuration information may include an indication for each transmission parameter. The indication may indicate whether that transmission parameter is to be included in the first portion or the second portion of contention-based uplink communications. For example, the configuration information may separately configure whether each transmission parameter is to be included in the first portions or the second portions.

In some examples, the configuration information may include information for enabling the UE 120 to determine or generate a UE identifier. For example, the configuration information may indicate that the identifier indicated by the UE 120 is to change over time, such as in a UE identifier hopping manner. For example, the configuration information may indicate that the UE identifier is to be changed as a function of time (e.g., changed in each slot, mini-slot frame, subframe, symbol, or other time interval), as a function of frequency (e.g., changed in each subband, starting physical resource block (PRB), or other frequency resource), or as a function of the time-frequency resource (e.g., changed for each resource identifier within a resource pool) used for transmitting the first portion, among other examples. For example, the change may be based on a pseudo-random sequence with an initialization parameter (e.g., an initialization identifier or a seed) that is indicated by the configuration information. For example, the configuration information may indicate the initialization parameter for UE identifier generation. If the configuration information does not indicate the initialization parameter, then the UE 120 may use a cell identifier (e.g., a physical cell identifier (PCI)) as the initialization parameter. In some aspects, the UE 120 may be capable of generating a set of identifiers using the initialization parameter (e.g., the initialization identifier). In some aspects, the configuration information may indicate a subset of identifiers, from the set of identifiers, from which the UE 120 is to select an identifier. For example, the configuration information may indicate an allowed range of UE identifiers. In other words, the UE 120 may be limited or restricted to using the subset of identifiers when performing UE identifier hopping as part of the contention-based uplink communications. This may improve coexistence between UEs configured to perform UE identifier hopping and other UEs that are not configured to perform UE identifier hopping (e.g., to prevent or reduce the likelihood of a collision in which two UEs use the same UE identifier). Additionally, by the UE 120 performing UE identifier hopping, security may be improved because the change in the UE identifier over time increases the difficulty for attackers or unauthorized parties or devices to track or predict the identifier of the UE over time. The pseudo-random changes to the UE identifier mean that even if an attacker intercepts a transmission, the attacker won’t be able to use the identifier reliably in future contention-based uplink communications from the UE 120 because the identifier of the UE 120 will change, thus reducing the risk of unauthorized access or data breaches.

In some examples, the configuration information may include information for enabling the UE 120 to determine or generate one or more encryption parameters for encrypting the first portions of the contention-based uplink communications. The one or more encryption parameters may include an encryption key. For example, the configuration information may indicate that the encryption key used by the UE 120 to encrypt the first portion is to change over time, such as in an encryption key hopping manner. For example, the configuration information may indicate that the encryption key is to be changed as a function of time (e.g., changed in each slot, mini-slot frame, subframe, symbol, or other time interval), as a function of frequency (e.g., changed in each subband, starting PRB, or other frequency resource), or as a function of the time-frequency resource (e.g., changed for each resource identifier within a resource pool) used for transmitting the first portion, among other examples. For example, the change may be based on a pseudo-random sequence with an initialization parameter (e.g., an initialization key or seed) that is indicated by the configuration information. For example, the configuration information may indicate the initialization parameter for encryption key generation. If the configuration information does not indicate the initialization parameter, then the UE 120 may use a cell identifier (e.g., a PCI) as the initialization parameter. In some aspects, the UE 120 may be capable of generating a set of values for the encryption key using the initialization parameter (e.g., the initialization identifier). In some aspects, the configuration information may indicate a subset of values, from the set of values, that are available for use by the UE 120. For example, the configuration information may indicate an allowed range of values of the encryption key. In other words, the UE 120 may be limited or restricted to using the subset of values when performing encryption key hopping as part of the contention-based uplink communications. This may improve coexistence between UEs configured to perform UE identifier hopping and other UEs that are not configured to perform UE identifier hopping (e.g., to prevent or reduce the likelihood of a collision in which two UEs use the same encryption keys). Additionally, by the UE 120 performing encryption key hopping, security may be improved because even if the encryption key for a first contention-based uplink communication is obtained by an unauthorized party or device, the value of the encryption key will change for a second contention-based uplink communication. As a result, the unauthorized party or device will be unable to decrypt or decode the first portion of the second contention-based uplink using the encryption key from the first contention-based uplink communication.

The UE 120 may configure itself based at least in part on the configuration information. In some aspects, the UE 120 may be configured to perform one or more operations described herein based at least in part on the configuration information.

As shown by reference number 315, the UE 120 may determine an identifier (e.g., a UE identifier) for a contention-based uplink communication. For example, the UE 120 may determine the identifier to be included in, or indicated by, the first portion of the contention-based uplink communication. In some aspects, the UE identifier may be fixed (e.g., may not change over time). In other aspects, the UE identifier may be variable or change over time (e.g., as a function of time, frequency, or a selected time-frequency resource). For example, the UE identifier may be a function of the initialization parameter (e.g., indicated by the configuration information) and a time parameter (e.g., indicating a current time interval, such as a current slot, frame, subframe, mini-slot, or symbol), a frequency parameter (e.g., indicating frequency resources used by the UE 120, such as a sub-band or a starting PRB), or a time-frequency resource used to transmit the first portion (e.g., that is selected by the UE 120 from the configured time-frequency resource pool). In some aspects, the UE 120 may determine the UE identifier using the initialization parameter and in association with a time window. For example, the initialization of the UE identifier may be reset at the beginning of a time duration or time window (e.g., may be reset every T slots or frames). In some examples, the UE 120 may generate the UE 120 from the subset of identifiers (e.g., indicated by an allowed range of identifiers, as indicated by the configuration information).

As an example, the UE 120 may generate a pseudo-random sequence based on the initialization parameter and one or more other parameters (e.g., the time parameter, the frequency parameter, or a resource identifier of a selected time-frequency resource). The UE 120 may use the pseudo-random sequence to determine, generate, or derive the UE identifier, ensuring that the UE identifier changes in a manner that is predictable to the network node but difficult for an attacker to anticipate, thereby enhancing security of the UE identifier.

As shown by reference number 320, the UE 120 may determine one or more encryption parameters for the contention-based uplink communication. For example, the UE 120 may determine one or more encryption parameters for the first encryption level or the second encryption level. The one or more encryption parameters may include an encryption key, an initialization vector, a cipher mode, a padding scheme, an encryption key length, a key derivation function, or an encryption algorithm or protocol, among other examples. For example, for the second encryption level, the UE 120 and the network node 110 may exchange UE-specific encryption information, such as an encryption key to be used by the UE 120 to encrypt second portions of contention-based uplink communications.

In some aspects, the UE 120 may determine that no encryption is to be applied for the first portion of the contention-based uplink communication. In other examples, the UE 120 may determine that resource-specific encryption is to be applied to the first portion of the contention-based uplink communication. For example, the UE 120 may select one or more time-frequency resources (e.g., from the configured time-frequency resource pool) for transmitting the first portion. One or more encryption parameters for the resource-specific encryption may be associated with the one or more time-frequency resources (e.g., may be associated with a resource identifier of the one or more time-frequency resources). For example, the one or more encryption parameters may be mapped to the one or more time-frequency resources or the resource identifier of the one or more time-frequency resources (e.g., as indicated in the configuration information). By the UE 120 using one or more encryption parameters (e.g., an encryption key) mapped to the time-frequency resource(s), the network node 110 is enabled to identify the one or more encryption parameters based on the time-frequency resource(s) via which the first portion is received by the network node 110.

In some aspects, the UE 120 may determine the one or more encryption parameters using encryption key hopping, as described above. For example, encryption key hopping involves the UE 120 changing the encryption key based on a pseudo-random sequence with an initialization parameter (e.g., a seed) that is configured via the configuration information. This increases security by ensuring that even if an attacker decodes the first portion and obtains the encryption key, the same encryption key cannot be used by the attacker to decode or decrypt future transmissions of contention-based uplink communications. As described elsewhere herein, the UE 120 may determine the encryption key using the initialization parameter and as a function of time (e.g., per slot, frame, or subframe), frequency (e.g., subband or starting physical resource block), or the specific resource used for transmitting the first portion. As a result, the encryption key for each transmission instance may be dynamically generated, reducing the likelihood of unauthorized decryption. For example, this ensures that even if an encryption key is compromised, the compromised encryption key will only be valid for a short duration, thereby limiting potential damage.

The initialization parameter or seed used for encryption key hopping can be provided to the UE 120 through configuration information from the network node 110 (e.g., via the configuration information). If the initialization parameter is not configured, the UE 120 may use the PCI as the initialization parameter. The initialization process for encryption key generation may be reset periodically at the beginning of a designated time window (e.g., every multiple slots or frames) to further enhance security. Additionally, the encryption key hopping can be confined to a subset of values within a larger set of possible encryption keys, ensuring coexistence between UEs that are configured for encryption key hopping and those that are not. This subset of values can be specified by the network through RRC configuration (e.g., via the configuration information), enabling the network node 110 to manage the encryption parameters effectively and maintain secure communications.

As shown by reference number 325, the UE 120 may encode, using the first encryption level, the first portion of the contention-based uplink communication. As described above, the first portion may include, or identify, an identifier of the UE (e.g., the UE identifier), such as the UE identifier determined by the UE 120 as described in connection with reference number 315. In some aspects, the first portion may include additional information (e.g., in addition to the UE identifier) associated with the second portion. This additional information may enable efficient and secure transmission of the second portion. For example, the first portion may include one or more transmission parameters that enable the network node 110 to correctly interpret and process the second portion. The transmission parameters can include resource allocation information (e.g., one or more time-frequency resources selected by the UE 120 for transmission of the second portion). Additionally, or alternatively, the one or more transmission parameters may include a HARQ identifier, an NDI, an RV, an MCS, and an indication of whether the second portion will be transmitted (e.g., for configured grant skipping), or information associated with the payload size of the second portion, among other examples.

Including this additional information in the first portion can significantly enhance the overall communication process. It allows the network to prepare for and efficiently handle the incoming second portion, even if the first portion is only partially encrypted or not encrypted at all. This is particularly beneficial in scenarios where the first portion is transmitted using a lower encryption level or a group-common encryption key, which may not provide the same level of security as UE-specific encryption. By embedding essential transmission parameters in the first portion, the network can still maintain a high level of control and coordination, ensuring that the second portion, which is encrypted with a more secure UE-specific encryption key, is accurately received and processed. This approach balances the need for security with the practical requirements of network communication, enabling robust and efficient uplink transmissions in next-generation wireless systems.

The UE 120 may encode the first portion without applying encryption (e.g., without using an encryption algorithm), such as when the first encryption level indicates that no encryption is to be applied to the first portion. For example, the identifier of the UE may be transmitted without any encryption. For example, the UE 120 may encode (e.g., may perform a first channel encoding operation) using an unencrypted version of the first portion to obtain an encoded first portion of the contention-based uplink communication. This simplifies the transmission of the first portion and reduces processing overhead.

In some other aspects, the UE 120 may encode the first portion using resource-specific encryption. For example, the UE 120 may determine one or more encryption parameters based on the time-frequency resource(s) selected to transmit the first portion (e.g., by identifying one or more encryption parameters mapped to the time-frequency resource(s)). For example, the UE 120 may identify an encryption key that is mapped to the time-frequency resource(s) selected to transmit the first portion. As part of encoding the first portion, the UE 120 may encrypt content included in the first portion using the encryption key. For example, the UE 120 may apply an encryption scheme or algorithm (e.g., a ciphering scheme or algorithm) to the content included in the first portion prior to encoding the first portion. For example, the UE 120 may encode (e.g., may perform a first channel encoding operation) using an encrypted version of the first portion to obtain an encoded first portion of the contention-based uplink communication.

This encryption secures the first portion and also ensures that the network node 110 is enabled to decode the first portion accurately by using the corresponding encryption parameter(s) associated with the time-frequency resource(s). As a result, the UE 120 and the network node 110 may leverage the dynamic nature of selected resource(s) for contention-based uplink communications to provide robust security for the first portion of the contention-based uplink communication. The resource-specific encryption may be an elliptic curve integrated encryption scheme, an advanced encryption standard (AES) scheme, a ciphering encryption scheme, an integrity protection scheme, a ZUC encryption scheme, a SNOW encryption scheme, or another type of encryption.

As shown by reference number 330, the UE 120 may encode, using the second encryption level, the second portion of the contention-based uplink communication. For example, as shown in FIG. 3, the UE 120 may separately perform channel encoding for the first portion and the second portion of the contention-based uplink communication. This enables the UE 120 to apply different encryption levels to the first portion and the second portion of the contention-based uplink communication. For example, the UE 120 may identify an encryption key that is associated with the second encryption level and that is specific to the UE 120. The UE 120 may use the encryption key and an encryption scheme or algorithm (e.g., a ciphering scheme) to encrypt content included in the second portion of the contention-based uplink communication. After encrypting the content of the second portion, the UE 120 may encode (e.g., may perform a second channel encoding operation) an encrypted version of the second portion to obtain an encoded second portion of the contention-based uplink communication. The second encryption level may include or use an elliptic curve integrated encryption scheme, an AES scheme, a ciphering encryption scheme, an integrity protection scheme, a ZUC encryption scheme, a SNOW encryption scheme, or another type of encryption.

In examples where encryption is applied to both the first portion and the second portion, the UE 120 may apply a stronger or higher level of encryption to the second portion of the contention-based uplink communication. For example, the first encryption level may be associated with a first encryption key (e.g., a first secret key) and the second encryption level may be associated with a second encryption key (e.g., a second secret key). The first encryption key may be smaller (or shorter) than the second encryption key. For example, the first encryption key may use fewer bits than the second encryption key. As an example, the first encryption key may be a 32 bit encryption key and the second encryption key may be a 128 bit encryption key. As another example, the first encryption key may be a 128 bit encryption key and the second encryption key may be a 256 bit encryption key. By the UE 120 applying different levels of encryption to the different portions, an efficiency of the use of processing resources for encryption may be improved while ensuring that the more sensitive data included in the second portion is given a higher level of security, thereby enhancing overall communication security without compromising performance.

As shown by reference number 335, the UE 120 may transmit, and the network node 110 may receive, the contention-based uplink communication. For example, the UE 120 may transmit, and the network node 110 may receive, as part of the contention-based uplink communication, the encoded first portion and the encoded second portion of the contention-based uplink communication. In some examples, the UE 120 may transmit, and the network node 110 may receive, the encoded first portion and the encoded second portion using the same time-frequency resources. For example, the UE 120 may transmit, and the network node 110 may receive, both the encoded first portion and the encoded second portion using the same one or more time-frequency resources.

In other aspects, the UE 120 may transmit, and the network node 110 may receive, the encoded first portion and the encoded second portion using different time-frequency resources. For example, the UE 120 may transmit, and the network node 110 may receive, the encoded first portion using one or more first time-frequency resources. The UE 120 may transmit, and the network node 110 may receive, the encoded second portion using one or more second time-frequency resources. The one or more first time-frequency resources may be different than the one or more second time-frequency resources. In such examples, the first portion may include an indication of the one or more second time-frequency resources that are used by the UE 120 to transmit the second portion. This enables the network node 110 to identify the one or more second time-frequency resources and to detect or otherwise receive the second portion of the contention-based uplink communication.

In some aspects, the UE 120 may transmit, and the network node 110 may receive, the first portion using Layer 1 signaling or physical layer signaling, such as in examples where the first encryption level indicates that no encryption is applied to the first portion (e.g., in examples where the first portion is unencrypted). For example, the UE 120 may transmit the first portion via UCI signaling (e.g., the first portion may be included in UCI). In such examples, the UE 120 may transmit the Layer 1 signaling or the UCI as a control channel communication, such as a PUCCH communication. In other examples, the UE 120 may transmit the Layer 1 signaling or the UCI as part of a data channel communication, such as a PUSCH communication. For example, the UE 120 may multiplex the first portion in a PUSCH communication as UCI. In such examples, the UE 120 may transmit, and the network node 110 may receive, the first portion and the second portion using the same time-frequency resources.

In some other aspects, the UE 120 may transmit, and the network node 110 may receive, the first portion using Layer 2 signaling, data link layer signaling, or MAC signaling, such as in examples where the first encryption level indicates that encryption is applied to the first portion (e.g., in examples where the first portion is encrypted, such as via the resource-specific encryption). For example, the first portion may be included in one or more MAC-CEs. In such examples, the first portion may be included in a payload of a data channel communication, such as a PUSCH communication. In some other aspects, the UE 120 may transmit, and the network node 110 may receive, the first portion using higher layer signaling, such as Layer 3 signaling, RRC signaling, or other higher layer signaling (such as in examples where the first encryption level indicates that encryption is applied to the first portion). In such examples, the UE 120 may transmit the first portion in a MAC protocol data unit (PDU) (such as a MAC sub-PDU) that includes a MAC service data unit (SDU). For example, the MAC sub-PDU may be included in a payload of a data channel communication, such as a PUSCH communication.

In some aspects, the UE 120 may transmit, and the network node 110 may receive, the second portion using Layer 2 signaling, data link layer signaling, or MAC signaling. For example, the second portion may be included in one or more MAC-CEs. In such examples, the second portion may be included in a payload of a data channel communication, such as a PUSCH communication. In some other aspects, the UE 120 may transmit, and the network node 110 may receive, the second portion using higher layer signaling, such as Layer 3 signaling, RRC signaling, or other higher layer signaling (such as in examples where the first encryption level indicates that encryption is applied to the first portion). In such examples, the UE 120 may transmit the second portion in a MAC PDU (such as a MAC sub-PDU) that includes a MAC SDU. For example, the MAC sub-PDU may be included in a payload of a data channel communication, such as a PUSCH communication.

As shown by reference number 340, the network node 110 may decode, using the first encryption level, the encoded first portion of the contention-based uplink communication to obtain the first portion of the contention-based uplink communication. For example, the network node 110 may perform a first channel decoding operation using the encoded first portion received from the UE 120. In some examples, such as where the first portion is unencrypted, the network node 110 may obtain the first portion of the contention-based uplink communication via the first channel decoding operation. In other examples, the network node 110 may obtain an encrypted version of the first portion of the contention-based uplink communication via the first channel decoding operation. In such examples, the network node 110 may decrypt the encrypted version of the first portion of the contention-based uplink communication using the first encryption level.

For example, the network node 110 may identify one or more encryption parameters based on the time-frequency resource(s) via which the encoded first portion was received. For example, an encryption key or other encryption parameters may be mapped to, or be otherwise associated with, the time-frequency resource(s) via which the encoded first portion was received by the network node 110. Additionally, or alternatively, the network node 110 may determine the one or more encryption parameters using an encryption key hopping scheme, as described in more detail elsewhere herein, such as in connection with reference number 320. The network node 110 may use the one or more encryption parameters to decrypt the encrypted version of the first portion. The network node 110 may obtain the first portion of the contention-based uplink communication based on decrypting the encrypted version of the first portion. The network node 110 may obtain or identify the identifier of the UE 120 (e.g., the UE identifier) from the first portion of the contention-based uplink communication. This enables the network node 110 to identify which UE has transmitted the contention-based uplink communication. This enables the network node 110 to identify one or more encryption parameters associated with the second encryption level (e.g., a UE-specific encryption) that is applied to the second portion of the contention-based uplink communication.

In some aspects, the first portion may include, or indicate, one or more transmission parameters associated with the second portion, such as time-frequency resource(s) used by the UE 120 to transmit the second portion, a HARQ identifier, an NDI, an RV, an MCS, an indication of whether the UE 120 transmits the second portion or skips transmission of the second portion, or an indication associated with a payload size of the second portion, among other examples. In such examples, the network node 110 may identify the one or more transmission parameters based on decoding or decrypting the first portion. The network node 110 may use the one or more transmission parameters to detect, decode, or otherwise receive the second portion of the contention-based uplink communication.

As shown by reference number 345, the network node 110 may decode, using the second encryption level, the encoded second portion of the contention-based uplink communication to obtain the second portion of the contention-based uplink communication. For example, the network node 110 may obtain the UE identifier of the UE 120 via the first portion of the contention-based uplink communication. In some examples, the network node 110 may identify the UE 120 based on the UE identifier. The network node 110 may determine or identify one or more encryption parameters for the second encryption level based on, or otherwise associated with, the UE 120 or the UE identifier. For example, the network node 110 and the UE 120 may have performed a key exchange or other security operation to exchange the one or more encryption parameters for the second encryption level (e.g., for UE-specific encryption). The network node 110 may identify the one or more encryption parameters that are mapped to the UE 120 or to the UE identifier.

The network node 110 may perform a second channel decoding operation using the encoded second portion received from the UE 120. The network node 110 may obtain an encrypted version of the second portion of the contention-based uplink communication via the second channel decoding operation. In such examples, the network node 110 may decrypt the encrypted version of the second portion of the contention-based uplink communication using the second encryption level. For example, the network node 110 may use the one or more encryption parameters for the second encryption level (e.g., for UE-specific encryption) to decrypt the encrypted version of the second portion. The network node 110 may obtain the second portion of the contention-based uplink communication based on, or otherwise associated with, decrypting the encrypted version of the second portion. As described elsewhere herein, the second portion may include a CSI report, a beam report, an event-triggered report, a BSR, HARQ feedback information, a TCP acknowledgement indication, uplink control information, or uplink data, among other examples.

As indicated above, FIG. 3 is provided as an example. Other examples may differ from what is described with respect to FIG. 3.

FIG. 4 is a diagram illustrating an example process 400 performed, for example, at a UE or an apparatus of a UE. Example process 400 is an example where the apparatus or the UE (e.g., the UE 120) performs operations associated with security for contention-based transmissions.

As shown in FIG. 4, in some aspects, process 400 may include encoding, using a first encryption level, a first portion of a contention-based uplink communication to obtain an encoded first portion, the first portion indicating an identifier of the UE (block 410). For example, the UE (e.g., using communication manager 606, depicted in FIG. 6) may encode, using a first encryption level, a first portion of a contention-based uplink communication to obtain an encoded first portion, the first portion indicating an identifier of the UE, as described above.

As further shown in FIG. 4, in some aspects, process 400 may include encoding, using a second encryption level, a second portion of the contention-based uplink communication to obtain an encoded second portion (block 420). For example, the UE (e.g., using communication manager 606, depicted in FIG. 6) may encode, using a second encryption level, a second portion of the contention-based uplink communication to obtain an encoded second portion, as described above.

As further shown in FIG. 4, in some aspects, process 400 may include transmitting, as part of the contention-based uplink communication, the encoded first portion and the encoded second portion (block 430). For example, the UE (e.g., using transmission component 604 or communication manager 606, depicted in FIG. 6) may transmit, as part of the contention-based uplink communication, the encoded first portion and the encoded second portion, as described above.

Process 400 may include additional aspects, such as any single aspect or any combination of aspects described below or in connection with one or more other processes described elsewhere herein.

In a first aspect, the first encryption level indicates that no encryption is applied to the first portion.

In a second aspect, alone or in combination with the first aspect, the first encryption level indicates that a resource-specific encryption is applied to the first portion.

In a third aspect, alone or in combination with one or more of the first and second aspects, transmitting the encoded first portion and the encoded second portion includes transmitting the encoded first portion using one or more time-frequency resources, where one or more encryption parameters for the resource-specific encryption are associated with the one or more time-frequency resources.

In a fourth aspect, alone or in combination with one or more of the first through third aspects, process 400 includes receiving configuration information that indicates sets of one or more encryption parameters for the resource-specific encryption, where the sets of one or more encryption parameters are associated with respective time-frequency resources included in a time-frequency resource pool for the contention-based uplink communication.

In a fifth aspect, alone or in combination with one or more of the first through fourth aspects, the first encryption level is associated with a first encryption key, and the second encryption level is associated with a second encryption key.

In a sixth aspect, alone or in combination with one or more of the first through fifth aspects, the first encryption key is shorter than the second encryption key.

In a seventh aspect, alone or in combination with one or more of the first through sixth aspects, the second portion includes at least one of a channel state information report, a beam report, an event-triggered report, a buffer status report, a hybrid automatic repeat request feedback indication, a transmission control protocol acknowledgement indication, or uplink data.

In an eighth aspect, alone or in combination with one or more of the first through seventh aspects, transmitting the encoded first portion and the encoded second portion includes transmitting both the encoded first portion and the encoded second portion using a same one or more time-frequency resources.

In a ninth aspect, alone or in combination with one or more of the first through eighth aspects, transmitting the encoded first portion and the encoded second portion includes transmitting the encoded first portion using one or more first time-frequency resources, and transmitting the encoded second portion using one or more second time-frequency resources, where the one or more first time-frequency resources are different than the one or more second time-frequency resources.

In a tenth aspect, alone or in combination with one or more of the first through ninth aspects, the first portion includes one or more transmission parameters associated with the second portion.

In an eleventh aspect, alone or in combination with one or more of the first through tenth aspects, the one or more transmission parameters include one or more time-frequency resources to be used to transmit the encoded second portion.

In a twelfth aspect, alone or in combination with one or more of the first through eleventh aspects, the one or more transmission parameters include at least one of a hybrid automatic repeat request identifier, a new data indicator, a redundancy version, a modulation and coding scheme, an indication of whether the second portion is to be transmitted, or an indication associated with a payload size of the second portion.

In a thirteenth aspect, alone or in combination with one or more of the first through twelfth aspects, process 400 includes receiving configuration information that indicates first content to be included in the first portion and second content to be included in the second portion.

In a fourteenth aspect, alone or in combination with one or more of the first through thirteenth aspects, the configuration information indicates whether the first content is to include one or more transmission parameters associated with the second portion.

In a fifteenth aspect, alone or in combination with one or more of the first through fourteenth aspects, the identifier of the UE is a function of an initialization parameter and at least one of a time parameter, a frequency parameter, or a time-frequency resource used to transmit the first portion.

In a sixteenth aspect, alone or in combination with one or more of the first through fifteenth aspects, process 400 includes receiving configuration information that indicates the initialization parameter.

In a seventeenth aspect, alone or in combination with one or more of the first through sixteenth aspects, process 400 includes determining the identifier of the UE using the initialization parameter and in association with a time window.

In an eighteenth aspect, alone or in combination with one or more of the first through seventeenth aspects, the identifier of the UE is included in a subset of identifiers from a set of identifiers.

In a nineteenth aspect, alone or in combination with one or more of the first through eighteenth aspects, process 400 includes receiving configuration information that indicates the subset of identifiers.

In a twentieth aspect, alone or in combination with one or more of the first through nineteenth aspects, the first encryption level is associated with one or more encryption parameters, and the one or more encryption parameters are a function of an initialization parameter and at least one of a time parameter, a frequency parameter, or a time-frequency resource used to transmit the first portion.

In a twenty-first aspect, alone or in combination with one or more of the first through twentieth aspects, the one or more encryption parameters include an encryption key.

In a twenty-second aspect, alone or in combination with one or more of the first through twenty-first aspects, process 400 includes receiving configuration information that indicates the initialization parameter.

In a twenty-third aspect, alone or in combination with one or more of the first through twenty-second aspects, process 400 includes determining the one or more encryption parameters using the initialization parameter and in association with a time window.

In a twenty-fourth aspect, alone or in combination with one or more of the first through twenty-third aspects, the one or more encryption parameters have one or more values included in a subset of values from a set of values.

In a twenty-fifth aspect, alone or in combination with one or more of the first through twenty-fourth aspects, process 400 includes receiving configuration information that indicates the subset of values.

In a twenty-sixth aspect, alone or in combination with one or more of the first through twenty-fifth aspects, transmitting the encoded first portion and the encoded second portion includes transmitting the encoded first portion via at least one of Layer 1 signaling, uplink control information signaling, Layer 2 signaling, medium access control signaling, or higher layer signaling.

In a twenty-seventh aspect, alone or in combination with one or more of the first through twenty-sixth aspects, transmitting the encoded first portion and the encoded second portion includes transmitting the encoded second portion via at least one of Layer 2 signaling, medium access control signaling, or higher layer signaling.

In a twenty-eighth aspect, alone or in combination with one or more of the first through twenty-seventh aspects, the second encryption level includes a UE-specific encryption.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node. Example process 500 is an example where the apparatus or the network node (e.g., the network node 110) performs operations associated with security for contention-based transmissions.

As shown in FIG. 5, in some aspects, process 500 may include receiving, as part of a contention-based uplink communication associated with a UE, an encoded first portion of the contention-based uplink communication and an encoded second portion of the contention-based uplink communication (block 510). For example, the network node (e.g., using reception component 702 or communication manager 706, depicted in FIG. 7) may receive, as part of a contention-based uplink communication associated with a UE, an encoded first portion of the contention-based uplink communication and an encoded second portion of the contention-based uplink communication, as described above.

As further shown in FIG. 5, in some aspects, process 500 may include decoding, using a first encryption level, the encoded first portion to obtain a first portion of the contention-based uplink communication, the first portion indicating an identifier of the UE (block 520). For example, the network node (e.g., using communication manager 706, depicted in FIG. 7) may decode, using a first encryption level, the encoded first portion to obtain a first portion of the contention-based uplink communication, the first portion indicating an identifier of the UE, as described above.

As further shown in FIG. 5, in some aspects, process 500 may include decoding, using a second encryption level, the encoded second portion to obtain a second portion of the contention-based uplink communication (block 530). For example, the network node (e.g., using communication manager 706, depicted in FIG. 7) may decode, using a second encryption level, the encoded second portion to obtain a second portion of the contention-based uplink communication, as described above.

Process 500 may include additional aspects, such as any single aspect or any combination of aspects described below or in connection with one or more other processes described elsewhere herein.

In a first aspect, the first encryption level indicates that no encryption is applied to the encoded first portion.

In a second aspect, alone or in combination with the first aspect, the first encryption level indicates that a resource-specific encryption is applied to the encoded first portion.

In a third aspect, alone or in combination with one or more of the first and second aspects, receiving the encoded first portion and the encoded second portion includes receiving the encoded first portion using one or more time-frequency resources, where one or more encryption parameters for the resource-specific encryption are associated with the one or more time-frequency resources.

In a fourth aspect, alone or in combination with one or more of the first through third aspects, process 500 includes transmitting configuration information that indicates sets of one or more encryption parameters for the resource-specific encryption, where the sets of one or more encryption parameters are associated with respective time-frequency resources included in a time-frequency resource pool for the contention-based uplink communication.

In a fifth aspect, alone or in combination with one or more of the first through fourth aspects, the first encryption level is associated with a first encryption key, and the second encryption level is associated with a second encryption key.

In a sixth aspect, alone or in combination with one or more of the first through fifth aspects, the first encryption key is shorter than the second encryption key.

In a seventh aspect, alone or in combination with one or more of the first through sixth aspects, the second portion includes at least one of a channel state information report, a beam report, an event-triggered report, a buffer status report, a hybrid automatic repeat request feedback indication, a transmission control protocol acknowledgement indication, or uplink data.

In an eighth aspect, alone or in combination with one or more of the first through seventh aspects, receiving the encoded first portion and the encoded second portion includes receiving both the encoded first portion and the encoded second portion using a same one or more time-frequency resources.

In a ninth aspect, alone or in combination with one or more of the first through eighth aspects, receiving the encoded first portion and the encoded second portion includes receiving the encoded first portion using one or more first time-frequency resources, and receiving the encoded second portion using one or more second time-frequency resources, where the one or more first time-frequency resources are different than the one or more second time-frequency resources.

In a tenth aspect, alone or in combination with one or more of the first through ninth aspects, the first portion includes one or more transmission parameters associated with the second portion.

In an eleventh aspect, alone or in combination with one or more of the first through tenth aspects, the one or more transmission parameters include one or more time-frequency resources to be used to receive the encoded second portion.

In a twelfth aspect, alone or in combination with one or more of the first through eleventh aspects, the one or more transmission parameters include at least one of a hybrid automatic repeat request identifier, a new data indicator, a redundancy version, a modulation and coding scheme, an indication of whether the second portion is to be transmitted, or an indication associated with a payload size of the second portion.

In a thirteenth aspect, alone or in combination with one or more of the first through twelfth aspects, process 500 includes transmitting configuration information that indicates first content to be included in the first portion and second content to be included in the second portion.

In a fourteenth aspect, alone or in combination with one or more of the first through thirteenth aspects, the configuration information indicates whether the first content is to include one or more transmission parameters associated with the second portion.

In a fifteenth aspect, alone or in combination with one or more of the first through fourteenth aspects, the identifier of the UE is a function of an initialization parameter and at least one of a time parameter, a frequency parameter, or a time-frequency resource used to receive the encoded first portion.

In a sixteenth aspect, alone or in combination with one or more of the first through fifteenth aspects, process 500 includes transmitting configuration information that indicates the initialization parameter.

In a seventeenth aspect, alone or in combination with one or more of the first through sixteenth aspects, the identifier of the UE is included in a subset of identifiers from a set of identifiers.

In an eighteenth aspect, alone or in combination with one or more of the first through seventeenth aspects, process 500 includes transmitting configuration information that indicates the subset of identifiers.

In a nineteenth aspect, alone or in combination with one or more of the first through eighteenth aspects, the first encryption level is associated with one or more encryption parameters, and the one or more encryption parameters are a function of an initialization parameter and at least one of a time parameter, a frequency parameter, or a time-frequency resource used to receive the encoded first portion.

In a twentieth aspect, alone or in combination with one or more of the first through nineteenth aspects, the one or more encryption parameters include an encryption key.

In a twenty-first aspect, alone or in combination with one or more of the first through twentieth aspects, process 500 includes transmitting configuration information that indicates the initialization parameter.

In a twenty-second aspect, alone or in combination with one or more of the first through twenty-first aspects, the one or more encryption parameters have one or more values included in a subset of values from a set of values.

In a twenty-third aspect, alone or in combination with one or more of the first through twenty-second aspects, process 500 includes transmitting configuration information that indicates the subset of values.

In a twenty-fourth aspect, alone or in combination with one or more of the first through twenty-third aspects, receiving the encoded first portion and the encoded second portion includes receiving the encoded first portion via at least one of Layer 1 signaling, uplink control information signaling, Layer 2 signaling, medium access control signaling, or higher layer signaling.

In a twenty-fifth aspect, alone or in combination with one or more of the first through twenty-fourth aspects, receiving the encoded first portion and the encoded second portion includes receiving the encoded second portion via at least one of Layer 2 signaling, medium access control signaling, or higher layer signaling.

In a twenty-sixth aspect, alone or in combination with one or more of the first through twenty-fifth aspects, the second encryption level includes a UE-specific encryption.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4, or a combination thereof. In some aspects, the apparatus 600 or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The communication manager 606 may encode, using a first encryption level, a first portion of a contention-based uplink communication to obtain an encoded first portion, the first portion indicating an identifier of the UE. The communication manager 606 may encode, using a second encryption level, a second portion of the contention-based uplink communication to obtain an encoded second portion. The transmission component 604 may transmit, as part of the contention-based uplink communication, the encoded first portion and the encoded second portion.

The reception component 602 may receive configuration information that indicates sets of one or more encryption parameters for the resource-specific encryption, wherein the sets of one or more encryption parameters are associated with respective time-frequency resources included in a time-frequency resource pool for the contention-based uplink communication.

The reception component 602 may receive configuration information that indicates first content to be included in the first portion and second content to be included in the second portion. The reception component 602 may receive configuration information that indicates an initialization parameter for UE identifier generation. The communication manager 606 may determine the identifier of the UE using the initialization parameter and in association with a time window. The reception component 602 may receive configuration information that indicates a subset of usable identifiers.

The reception component 602 may receive configuration information that indicates an initialization parameter for encryption parameter generation. The communication manager 606 may determine the one or more encryption parameters using the initialization parameter and in association with a time window. The reception component 602 may receive configuration information that indicates the subset of usable values for the encryption parameters.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a network node, or a network node may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5, or a combination thereof. In some aspects, the apparatus 700 or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 or the transmission component 704 may include or may be included in a network interface. The network interface may be configured to obtain or output signals for the apparatus 700 via one or more communications links, such as a backhaul link, a midhaul link, or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, as part of a contention-based uplink communication associated with a UE, an encoded first portion of the contention-based uplink communication and an encoded second portion of the contention-based uplink communication. The communication manager 706 may decode, using a first encryption level, the encoded first portion to obtain a first portion of the contention-based uplink communication, the first portion indicating an identifier of the UE. The communication manager 706 may decode, using a second encryption level, the encoded second portion to obtain a second portion of the contention-based uplink communication.

The transmission component 704 may transmit configuration information that indicates sets of one or more encryption parameters for the resource-specific encryption, wherein the sets of one or more encryption parameters are associated with respective time-frequency resources included in a time-frequency resource pool for the contention-based uplink communication.

The transmission component 704 may transmit configuration information that indicates first content to be included in the first portion and second content to be included in the second portion.

The transmission component 704 may transmit configuration information that indicates an initialization parameter for UE identifier generation. The transmission component 704 may transmit configuration information that indicates a subset of usable UE identifiers.

The transmission component 704 may transmit configuration information that indicates an initialization parameter for encryption parameter generation. The transmission component 704 may transmit configuration information that indicates the subset of usable values for the encryption parameters.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: encoding, using a first encryption level, a first portion of a contention-based uplink communication to obtain an encoded first portion, the first portion indicating an identifier of the UE; encoding, using a second encryption level, a second portion of the contention-based uplink communication to obtain an encoded second portion; and transmitting, as part of the contention-based uplink communication, the encoded first portion and the encoded second portion.

Aspect 2: The method of Aspect 1, wherein the first encryption level indicates that no encryption is applied to the first portion.

Aspect 3: The method of any of Aspects 1-2, wherein the first encryption level indicates that a resource-specific encryption is applied to the first portion.

Aspect 4: The method of Aspect 3, wherein transmitting the encoded first portion and the encoded second portion comprises transmitting the encoded first portion using one or more time-frequency resources, wherein one or more encryption parameters for the resource-specific encryption are associated with the one or more time-frequency resources.

Aspect 5: The method of any of Aspects 3-4, further comprising: receiving configuration information that indicates sets of one or more encryption parameters for the resource-specific encryption, wherein the sets of one or more encryption parameters are associated with respective time-frequency resources included in a time-frequency resource pool for the contention-based uplink communication.

Aspect 6: The method of any of Aspects 1-5, wherein the first encryption level is associated with a first encryption key, and wherein the second encryption level is associated with a second encryption key.

Aspect 7: The method of Aspect 6, wherein the first encryption key is shorter than the second encryption key.

Aspect 8: The method of any of Aspects 1-7, wherein the second portion includes at least one of: a channel state information report, a beam report, an event-triggered report, a buffer status report, a hybrid automatic repeat request feedback indication, a transmission control protocol acknowledgement indication, or uplink data.

Aspect 9: The method of any of Aspects 1-8, wherein transmitting the encoded first portion and the encoded second portion comprises: transmitting both the encoded first portion and the encoded second portion using a same one or more time-frequency resources.

Aspect 10: The method of any of Aspects 1-8, wherein transmitting the encoded first portion and the encoded second portion comprises: transmitting the encoded first portion using one or more first time-frequency resources; and transmitting the encoded second portion using one or more second time-frequency resources, wherein the one or more first time-frequency resources are different than the one or more second time-frequency resources.

Aspect 11: The method of any of Aspects 1-10, wherein the first portion includes one or more transmission parameters associated with the second portion.

Aspect 12: The method of Aspect 11, wherein the one or more transmission parameters include one or more time-frequency resources to be used to transmit the encoded second portion.

Aspect 13: The method of any of Aspects 11-12, wherein the one or more transmission parameters include at least one of: a hybrid automatic repeat request identifier, a new data indicator, a redundancy version, a modulation and coding scheme, an indication of whether the second portion is to be transmitted, or an indication associated with a payload size of the second portion.

Aspect 14: The method of any of Aspects 1-13, further comprising: receiving configuration information that indicates first content to be included in the first portion and second content to be included in the second portion.

Aspect 15: The method of Aspect 14, wherein the configuration information indicates whether the first content is to include one or more transmission parameters associated with the second portion.

Aspect 16: The method of any of Aspects 1-15, wherein the identifier of the UE is a function of an initialization parameter and at least one of: a time parameter, a frequency parameter, or a time-frequency resource used to transmit the first portion.

Aspect 17: The method of Aspect 16, further comprising: receiving configuration information that indicates the initialization parameter.

Aspect 18: The method of any of Aspects 16-17, further comprising: determining the identifier of the UE using the initialization parameter and in association with a time window.

Aspect 19: The method of any of Aspects 16-18, wherein the identifier of the UE is included in a subset of identifiers from a set of identifiers.

Aspect 20: The method of Aspect 19, further comprising: receiving configuration information that indicates the subset of identifiers.

Aspect 21: The method of any of Aspects 1-20, wherein the first encryption level is associated with one or more encryption parameters, and wherein the one or more encryption parameters are a function of an initialization parameter and at least one of: a time parameter, a frequency parameter, or a time-frequency resource used to transmit the first portion.

Aspect 22: The method of Aspect 21, wherein the one or more encryption parameters include an encryption key.

Aspect 23: The method of any of Aspects 21-22, further comprising: receiving configuration information that indicates the initialization parameter.

Aspect 24: The method of any of Aspects 21-23, further comprising: determining the one or more encryption parameters using the initialization parameter and in association with a time window.

Aspect 25: The method of any of Aspects 21-24, wherein the one or more encryption parameters have one or more values included in a subset of values from a set of values.

Aspect 26: The method of Aspect 25, further comprising: receiving configuration information that indicates the subset of values.

Aspect 27: The method of any of Aspects 1-26, wherein transmitting the encoded first portion and the encoded second portion comprises: transmitting the encoded first portion via at least one of: Layer 1 signaling, uplink control information signaling, Layer 2 signaling, medium access control signaling, or higher layer signaling.

Aspect 28: The method of any of Aspects 1-27, wherein transmitting the encoded first portion and the encoded second portion comprises: transmitting the encoded second portion via at least one of: Layer 2 signaling, medium access control signaling, or higher layer signaling.

Aspect 29: The method of any of Aspects 1-28, wherein the second encryption level includes a UE-specific encryption.

Aspect 30: A method of wireless communication performed by a network node, comprising: receiving, as part of a contention-based uplink communication associated with a user equipment (UE), an encoded first portion of the contention-based uplink communication and an encoded second portion of the contention-based uplink communication; decoding, using a first encryption level, the encoded first portion to obtain a first portion of the contention-based uplink communication, the first portion indicating an identifier of the UE; and decoding, using a second encryption level, the encoded second portion to obtain a second portion of the contention-based uplink communication.

Aspect 31: The method of Aspect 30, wherein the first encryption level indicates that no encryption is applied to the encoded first portion.

Aspect 32: The method of any of Aspects 30-31, wherein the first encryption level indicates that a resource-specific encryption is applied to the encoded first portion.

Aspect 33: The method of Aspect 32, wherein receiving the encoded first portion and the encoded second portion comprises receiving the encoded first portion using one or more time-frequency resources, wherein one or more encryption parameters for the resource-specific encryption are associated with the one or more time-frequency resources.

Aspect 34: The method of any of Aspects 32-33, further comprising: transmitting configuration information that indicates sets of one or more encryption parameters for the resource-specific encryption, wherein the sets of one or more encryption parameters are associated with respective time-frequency resources included in a time-frequency resource pool for the contention-based uplink communication.

Aspect 35: The method of any of Aspects 30-34, wherein the first encryption level is associated with a first encryption key, and wherein the second encryption level is associated with a second encryption key.

Aspect 36: The method of Aspect 35, wherein the first encryption key is shorter than the second encryption key.

Aspect 37: The method of any of Aspects 30-36, wherein the second portion includes at least one of: a channel state information report, a beam report, an event-triggered report, a buffer status report, a hybrid automatic repeat request feedback indication, a transmission control protocol acknowledgement indication, or uplink data.

Aspect 38: The method of any of Aspects 30-37, wherein receiving the encoded first portion and the encoded second portion comprises: receiving both the encoded first portion and the encoded second portion using a same one or more time-frequency resources.

Aspect 39: The method of any of Aspects 30-37, wherein receiving the encoded first portion and the encoded second portion comprises: receiving the encoded first portion using one or more first time-frequency resources; and receiving the encoded second portion using one or more second time-frequency resources, wherein the one or more first time-frequency resources are different than the one or more second time-frequency resources.

Aspect 40: The method of any of Aspects 30-39, wherein the first portion includes one or more transmission parameters associated with the second portion.

Aspect 41: The method of Aspect 40, wherein the one or more transmission parameters include one or more time-frequency resources to be used to receive the encoded second portion.

Aspect 42: The method of any of Aspects 40-41, wherein the one or more transmission parameters include at least one of: a hybrid automatic repeat request identifier, a new data indicator, a redundancy version, a modulation and coding scheme, an indication of whether the second portion is to be transmitted, or an indication associated with a payload size of the second portion.

Aspect 43: The method of any of Aspects 30-42, further comprising: transmitting configuration information that indicates first content to be included in the first portion and second content to be included in the second portion.

Aspect 44: The method of Aspect 43, wherein the configuration information indicates whether the first content is to include one or more transmission parameters associated with the second portion.

Aspect 45: The method of any of Aspects 30-44, wherein the identifier of the UE is a function of an initialization parameter and at least one of: a time parameter, a frequency parameter, or a time-frequency resource used to receive the encoded first portion.

Aspect 46: The method of Aspect 45, further comprising: transmitting configuration information that indicates the initialization parameter.

Aspect 47: The method of any of Aspects 45-46, wherein the identifier of the UE is included in a subset of identifiers from a set of identifiers.

Aspect 48: The method of Aspect 47, further comprising: transmitting configuration information that indicates the subset of identifiers.

Aspect 49: The method of any of Aspects30-48, wherein the first encryption level is associated with one or more encryption parameters, and wherein the one or more encryption parameters are a function of an initialization parameter and at least one of: a time parameter, a frequency parameter, or a time-frequency resource used to receive the encoded first portion.

Aspect 50: The method of Aspect 49, wherein the one or more encryption parameters include an encryption key.

Aspect 51: The method of any of Aspects 49-50, further comprising: transmitting configuration information that indicates the initialization parameter.

Aspect52: The method of any of Aspects 49-51, wherein the one or more encryption parameters have one or more values included in a subset of values from a set of values.

Aspect 53: The method of Aspect 52, further comprising: transmitting configuration information that indicates the subset of values.

Aspect 54: The method of any of Aspects 30-53, wherein receiving the encoded first portion and the encoded second portion comprises: receiving the encoded first portion via at least one of: Layer 1 signaling, uplink control information signaling, Layer 2 signaling, medium access control signaling, or higher layer signaling.

Aspect 55: The method of any of Aspects30-54, wherein receiving the encoded first portion and the encoded second portion comprises: receiving the encoded second portion via at least one of: Layer 2 signaling, medium access control signaling, or higher layer signaling.

Aspect 56: The method of any of Aspects 30-55, wherein the second encryption level includes a UE-specific encryption.

Aspect 57: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects1-56.

Aspect 58: An apparatus for wireless communication at a device, the apparatus comprising one or more memories and one or more processors coupled to the one or more memories, the one or more processors configured to cause the device to perform the method of one or more of Aspects 1-56.

Aspect 59: An apparatus for wireless communication, the apparatus comprising at least one means for performing the method of one or more of Aspects 1-56.

Aspect 60: A non-transitory computer-readable medium storing code for wireless communication, the code comprising instructions executable by one or more processors to perform the method of one or more of Aspects 1-56.

Aspect 61: A non-transitory computer-readable medium storing a set of instructions for wireless communication, the set of instructions comprising one or more instructions that, when executed by one or more processors of a device, cause the device to perform the method of one or more of Aspects1-56.

Aspect 62: A device for wireless communication, the device comprising a processing system that includes one or more processors and one or more memories coupled with the one or more processors, the processing system configured to cause the device to perform the method of one or more of Aspects1-56.

Aspect 63: An apparatus for wireless communication at a device, the apparatus comprising one or more memories and one or more processors coupled to the one or more memories, the one or more processors individually or collectively configured to cause the device to perform the method of one or more of Aspects 1-56.

Aspect 64: A device comprising a processing system that includes one or more processors and one or more code-storing memories coupled with the one or more processors, the processing system configured to cause the device to perform the method of one or more of Aspects 1-56.

Aspect 65: A device comprising a processing system that includes processor circuitry and code-storing memory circuitry, the processing system configured to cause the device to perform the method of one or more of Aspects1-56.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
encode, using a first encryption level, a first portion of a contention-based uplink communication to obtain an encoded first portion, the first portion indicating an identifier of the UE;
encode, using a second encryption level, a second portion of the contention-based uplink communication to obtain an encoded second portion; and
transmit, as part of the contention-based uplink communication, the encoded first portion and the encoded second portion.

2. The UE of claim 1, wherein the first encryption level indicates that no encryption is applied to the first portion.

3. The UE of claim 1, wherein the first encryption level indicates that a resource-specific encryption is applied to the first portion.

4. The UE of claim 3, wherein transmitting the encoded first portion and the encoded second portion comprises transmitting the encoded first portion using one or more time-frequency resources, wherein one or more encryption parameters for the resource-specific encryption are associated with the one or more time-frequency resources.

5. The UE of claim 3, wherein the processing system is configured to cause the UE to:
receive configuration information that indicates sets of one or more encryption parameters for the resource-specific encryption, wherein the sets of one or more encryption parameters are associated with respective time-frequency resources included in a time-frequency resource pool for the contention-based uplink communication.

6. The UE of claim 1, wherein the first encryption level is associated with a first encryption key, and wherein the second encryption level is associated with a second encryption key.

7. The UE of claim 1, wherein, to cause the UE to transmit the encoded first portion and the encoded second portion, the processing system is configured to cause the UE to:
transmit both the encoded first portion and the encoded second portion using a same one or more time-frequency resources.

8. The UE of claim 1, wherein, to cause the UE to transmit the encoded first portion and the encoded second portion, the processing system is configured to cause the UE to:
transmit the encoded first portion using one or more first time-frequency resources; and
transmit the encoded second portion using one or more second time-frequency resources, wherein the one or more first time-frequency resources are different than the one or more second time-frequency resources.

9. The UE of claim 1, wherein the first portion includes one or more transmission parameters associated with the second portion.

10. The UE of claim 9, wherein the one or more transmission parameters include one or more time-frequency resources to be used to transmit the encoded second portion.

11. The UE of claim 9, wherein the one or more transmission parameters include at least one of:
a hybrid automatic repeat request identifier,
a new data indicator,
a redundancy version,
a modulation and coding scheme,
an indication of whether the second portion is to be transmitted, or
an indication associated with a payload size of the second portion.

12. The UE of claim 1, wherein the processing system is configured to cause the UE to:
receive configuration information that indicates first content to be included in the first portion and second content to be included in the second portion.

13. The UE of claim 1, wherein the identifier of the UE is a function of an initialization parameter and at least one of:
a time parameter,
a frequency parameter, or
a time-frequency resource used to transmit the first portion.

14. The UE of claim 1, wherein the first encryption level is associated with one or more encryption parameters, and wherein the one or more encryption parameters are a function of an initialization parameter and at least one of:
a time parameter,
a frequency parameter, or
a time-frequency resource used to transmit the first portion.

15. A network node, comprising:
a processing system that includes one or more processors and one or more code-storing memories coupled with the one or more processors, the processing system configured to cause the network node to:
receive, as part of a contention-based uplink communication from a user equipment (UE), an encoded first portion of the contention-based uplink communication and an encoded second portion of the contention-based uplink communication;
decode, using a first encryption level, the encoded first portion to obtain a first portion of the contention-based uplink communication, the first portion indicating an identifier of the UE; and
decode, using a second encryption level, the encoded second portion to obtain a second portion of the contention-based uplink communication.

16. The network node of claim 15, wherein the first encryption level indicates that no encryption is applied to the encoded first portion or that resource-specific encryption is applied to the encoded first portion.

17. The network node of claim 15, wherein the second portion includes at least one of:
a channel state information report,
a beam report,
an event-triggered report,
a buffer status report,
a hybrid automatic repeat request feedback indication,
a transmission control protocol acknowledgement indication, or
uplink data.

18. A method of wireless communication performed by a user equipment (UE), comprising:
encoding, using a first encryption level, a first portion of a contention-based uplink communication to obtain an encoded first portion, the first portion indicating an identifier of the UE;
encoding, using a second encryption level, a second portion of the contention-based uplink communication to obtain an encoded second portion; and
transmitting, as part of the contention-based uplink communication, the encoded first portion and the encoded second portion.

19. The method of claim 18, wherein transmitting the encoded first portion and the encoded second portion comprises:
transmitting the encoded first portion via at least one of:
Layer 1 signaling,
uplink control information signaling,
Layer 2 signaling,
medium access control signaling, or
higher layer signaling.

20. The method of claim 18, wherein transmitting the encoded first portion and the encoded second portion comprises:
transmitting the encoded second portion via at least one of:
Layer 2 signaling,
medium access control signaling, or
higher layer signaling.
